(19) United States
(12) Patent Application Publication
(10) Pub. No.: US 2025/0162559 A1
(43) Pub. Date: May 22, 2025

(54) ELECTRONIC CONTROL UNIT FOR ELECTRONIC BRAKE SYSTEM, AND HYDRAULIC ASSEMBLY

(71) Applicant: HL MANDO CORPORATION, Gyeonggi-do (KR)

(72) Inventor: Mingeun SONG, Daejeon (KR)

(21) Appl. No.: 18/838,545

(22) PCT Filed: Feb. 14, 2023
(86) PCT No.: PCT/KR2023/002137

§ 371 Date: Aug. 14, 2024

(30) Foreign Application Priority Data
Feb. 14, 2022 (KR) 10-2022-0018908

(51) Int. Cl. B60T 13/68; B60T 13/14; B60T 13/74

(52) U.S. Cl. CPC B60T 13/686; B60T 13/142; B60T 13/148; B60T 13/745; B60T 2270/402

(57) ABSTRACT

An electronic control unit for an electronic brake system, and a hydraulic assembly are disclosed. The electronic control unit comprises: a housing having a hydraulic block which is mounted on the front surface thereof and in which a plurality of valves, a flow path, and a pump are provided in order to regulate hydraulic brake pressure transmitted to a plurality of wheel cylinders; a control unit for controlling the plurality of valves and a motor which is accommodated in the housing and provides power to the pump; a first connector provided at the front surface of the housing so that the control unit can be electrically connected to an external device; and a second connector, wherein the first connector is disposed above the position at which the hydraulic block is mounted, and the second connector can be disposed below a reservoir mounted at a first side surface of the hydraulic block.

### TECHNICAL FIELD

The present disclosure relates to an electronic control unit and a hydraulic assembly for an electronic brake system, and more specifically, to an electronic control unit and a hydraulic assembly for an electronic brake system, which include two connectors disposed to reduce a size of a package without interference with other components of a hydraulic assembly, and a hydraulic assembly.

### BACKGROUND ART

An electronic brake system, which is intended to effectively prevent a slip phenomenon that may occur during braking, sudden acceleration, or rapid acceleration of a vehicle, generally includes a hydraulic block for controlling braking hydraulic pressure, and an electronic control unit for controlling the hydraulic block as well as a boosting device, a master cylinder, and a wheel cylinder of a vehicle brake system.

Inside a hydraulic block of a rectangular parallelepiped made of aluminum, a plurality of solenoid valves (NO/NC valve) controlling the braking hydraulic pressure transmitted to a wheel cylinder provided on each vehicle wheel, a check valve that allows only one-way flow of a brake fluid, a pump driven by a motor, and the like are installed.

A reservoir, the motor, the master cylinder, the electronic control unit, the wheel cylinder, etc., are mounted on the hydraulic block to form a hydraulic assembly. A size of the hydraulic assembly increases as various parts are mounted on the hydraulic block, but various devices such as a steering device, a suspension device, etc., including an engine are provided in an engine room of the vehicle in which the hydraulic assembly is installed, so a size of the hydraulic assembly need to be minimized by efficiently placing respective components.

### DISCLOSURE

### Technical Problem

The present disclosure provides an electronic control unit and a hydraulic assembly for an electronic brake system disposed to minimize sizes those of and to prevent interference between components while including two connectors.

### Technical Solution

According to one aspect of the present disclosure, an electronic control unit for an electronic brake system may include: a housing in which a hydraulic block in which a plurality of valves, flow paths, and pumps are installed to control braking hydraulic pressure supplied to a plurality of wheel cylinders is mounted on a front surface; a control unit accommodated inside the housing, and controlling a motor providing power to the pump, and the plurality of valves; and a first connector and a second connector provided on the front surface of the housing so as for the control unit to be electrically connected to an external device, and the first connector may be disposed above a position where the hydraulic block is mounted, and the second connector may be disposed below a reservoir mounted on a first side surface of the hydraulic block.

The second connector may be disposed at a higher position than a bottom of the hydraulic block.

The second connector may be disposed to be spaced apart from the first side surface of the hydraulic block by a predetermined distance not to interfere with the reservoir having a shape in which the bottom becomes higher as moving away from the hydraulic block.

The control unit may include a first control unit controlling some valves among the plurality of values, and
a second control unit controlling the remaining valves which are not controlled by the first control unit among the plurality of valves, and the first connector may be electrically connected to the first control unit, and the second connector may be electrically connected to the second control unit.

The electronic control unit for an electronic brake system may further include a brake fluid shield provided at an upper side of the second connector so as to prevent a brake fluid which may leak from the reservoir from flowing into the second connector.

According to one aspect of the present disclosure, an electronic control unit for an electronic brake system may include: a housing in which a hydraulic block in which a plurality of valves, flow paths, and pumps are installed to control braking hydraulic pressure supplied to a plurality of wheel cylinders is mounted on a front surface; a control unit accommodated inside the housing, and controlling a motor providing power to the pump, and the plurality of valves; and a first connector and a second connector provided on the front surface of the housing so as for the control unit to be electrically connected to an external device, and the first connector may be disposed above a position where the hydraulic block is mounted, and the second connector may be disposed below the position where the hydraulic block is mounted.

According to one aspect of the present disclosure, an electronic control unit for an electronic brake system may include: a housing in which a hydraulic block in which a plurality of valves, flow paths, and pumps are installed to control braking hydraulic pressure supplied to a plurality of wheel cylinders is mounted on a front surface; a control unit accommodated inside the housing, and controlling a motor providing power to the pump, and the plurality of valves; and a first connector and a second connector provided on the front surface of the housing so as for the control unit to be electrically connected to an external device, and the first connector may be disposed below a position where the hydraulic block is mounted, and the second connector may be disposed below a reservoir mounted on a first side surface of the hydraulic block.

According to one aspect of the present disclosure, an electronic control unit for an electronic brake system may include: a housing in which a hydraulic block in which a plurality of valves, flow paths, and pumps are installed to control braking hydraulic pressure supplied to a plurality of wheel cylinders is mounted on a front surface; a control unit accommodated inside the housing, and controlling a motor providing power to the pump, and the plurality of valves; and a first connector and a second connector provided on the front surface of the housing so as for the control unit to be electrically connected to an external device, and the first connector may be disposed at the outside of a first side surface of a position where the hydraulic block is mounted, and the second connector may be disposed at the outside of a second side surface of the position where the hydraulic block is mounted.

According to one aspect of the present disclosure, a hydraulic assembly for an electronic brake system may include: a hydraulic block in which a plurality of valves, flow paths, and pumps are installed to control braking hydraulic pressure supplied to a plurality of wheel cylinders; a motor mounted on a front surface of the hydraulic block, and providing power to the pump; a reservoir mounted above a first side surface of the hydraulic block, and storing a brake fluid; a master cylinder mounted on a second side surface of the hydraulic block, and generating liquid pressure; and an electronic control unit including a housing mounted on a back surface of the hydraulic block, a control unit accommodated inside the housing, and controlling the motor and the plurality of valves, and a first connector and a second connector provided on the front surface of the housing so as for the control unit to be electrically connected to an external device, and the first connector may be disposed above a position where the hydraulic block is mounted, and the second connector may be disposed below a position where the reservoir is mounted.

The second connector may be disposed at a higher position than a bottom of the hydraulic block.

The reservoir may have a shape in which a bottom becomes higher as moving away from the hydraulic block, and the second connector may be disposed to be spaced apart from the first side surface of the hydraulic block by a predetermined distance not to interfere with the reservoir.

The control unit may include a first control unit controlling some valves among the plurality of values, and a second control unit controlling the remaining valves which are not controlled by the first control unit among the plurality of valves, and the first connector may be electrically connected to the first control unit, and the second connector may be electrically connected to the second control unit.

The electronic control unit may further include a brake fluid shield provided at an upper side of the second connector so as to prevent a brake fluid which may leak from the reservoir from flowing into the second connector.

### Advantageous Effects

According to the exemplary embodiments, the electronic control unit and the hydraulic assembly for an electronic brake system can minimize a size of the hydraulic assembly by efficiently placing components.

According to the exemplary embodiments, the electronic control unit and the hydraulic assembly for an electronic brake system can enhance packaging and assemblability by compact placement.

According to the exemplary embodiments, the electronic control unit and the hydraulic assembly for an electronic brake system are connected by including two connectors to enhance operational reliability.

### DESCRIPTION OF DRAWINGS

FIG. 1 is a perspective view schematically illustrating a hydraulic assembly for an electronic brake system according to an exemplary embodiment of the present disclosure.

FIG. 2 is a front view schematically illustrating a hydraulic assembly for an electronic brake system according to an exemplary embodiment of the present disclosure.

FIG. 3 is a plan view schematically illustrating the hydraulic assembly for an electronic brake system according to an exemplary embodiment of the present disclosure.

FIG. 4 is a perspective view schematically illustrating a hydraulic block for an electronic brake system according to an exemplary embodiment of the present disclosure.

FIG. 5 is a perspective view schematically illustrating a hydraulic block for an electronic brake system viewed in another direction according to an exemplary embodiment of the present disclosure.

FIG. 6 is a front view schematically illustrating an electronic control unit for an electronic brake system according to an exemplary embodiment of the present disclosure.

FIG. 7 is a block diagram schematically illustrating an electronic control unit for an electronic brake system according to an exemplary embodiment of the present disclosure.

FIGS. 8 to 13 are front views schematically illustrating a hydraulic assembly for an electronic brake system according to another exemplary embodiment of the present disclosure.

### MODE FOR INVENTION

Like reference numerals refer to like elements throughout the specification. This specification does not describe all elements of the exemplary embodiments, and general content or content overlapping between the exemplary embodiments in the technical field to which the present disclosure pertains is omitted. The term ‘unit, module, member, block’ used in the specification may be implemented as software or hardware, and according to exemplary embodiments, a plurality of ‘units, modules, members, blocks’ may be implemented as one component or it is also possible that one ‘unit, module, member, block’ includes a plurality of components.

Throughout the specification, when a part is said to be “connected” with another part, this includes not only the case of direct connection, but also the case of indirect connection, and the indirect connection includes connection through a wireless communication network.

In addition, unless explicitly described to the contrary, the word “comprise”, and variations such as “comprises” or “comprising”, will be understood to imply the inclusion of stated elements but not the exclusion of any other elements.

Throughout this specification, it will be understood that when a member is referred to as being “on” another member, it can be directly on the other member or intervening members may also be present.

The terms “first,” “second,”, and the like are used to distinguish one component from other components, but the component is not limited by the terms. A singular form may include a plural form unless there is a clear exception in the context.

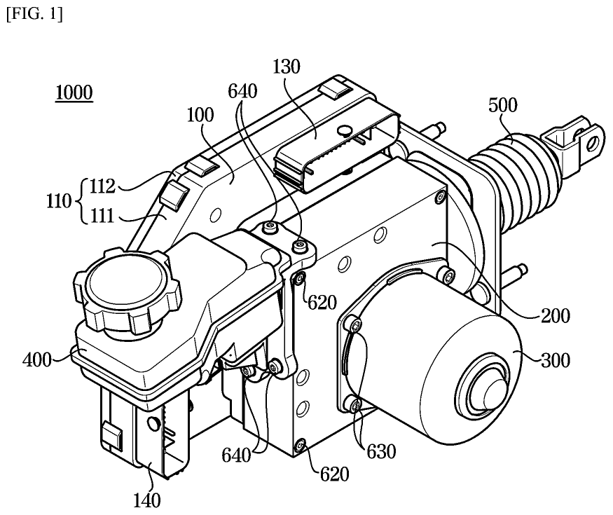

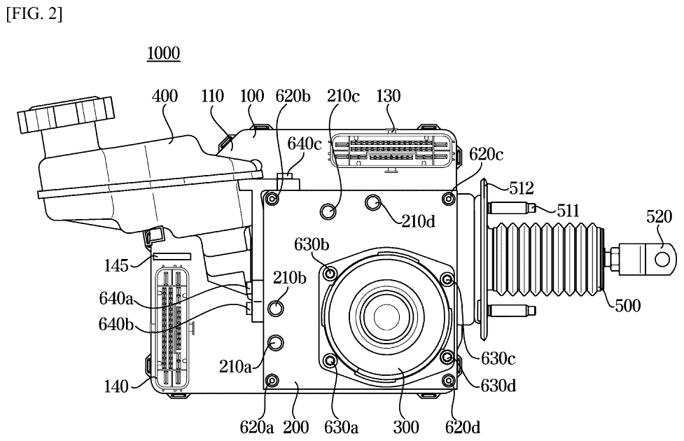

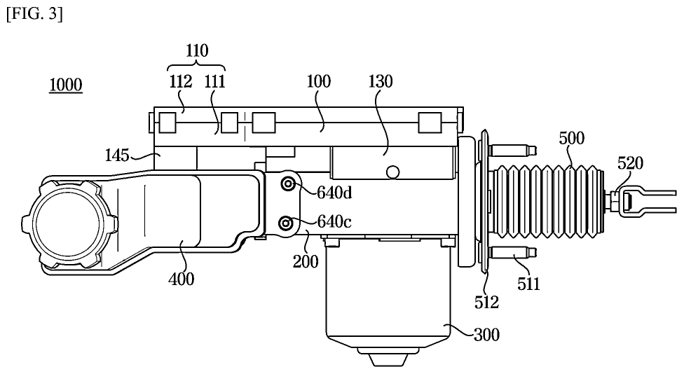

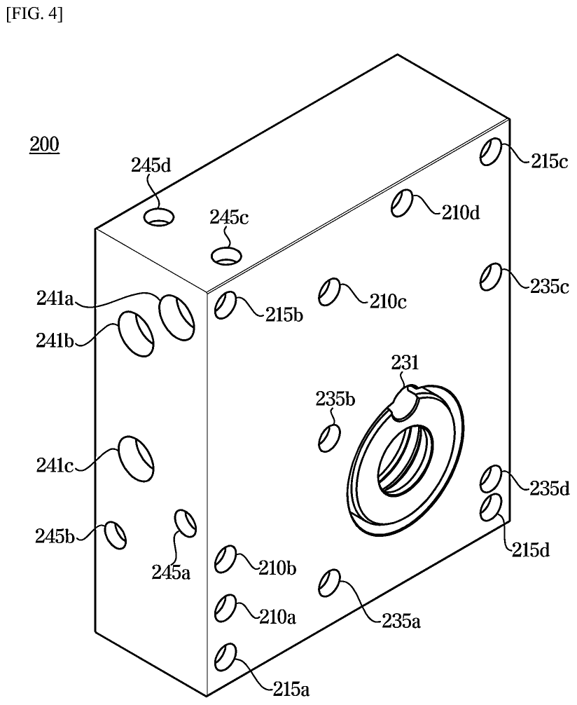

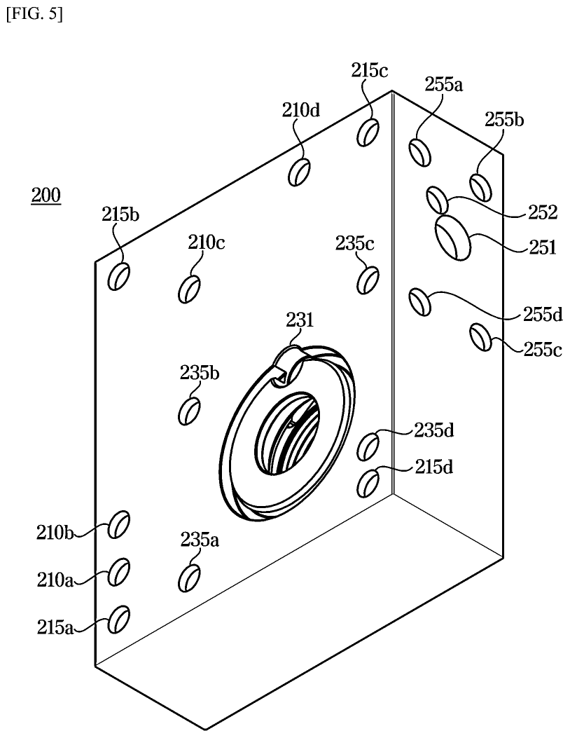

FIG. 1 is a perspective view schematically illustrating a hydraulic assembly for an electronic brake system according to an exemplary embodiment of the present disclosure, FIG. 2 is a front view schematically illustrating a hydraulic assembly for an electronic brake system according to an exemplary embodiment of the present disclosure, FIG. 3 is a plan view schematically illustrating the hydraulic assembly for an electronic brake system according to an exemplary embodiment of the present disclosure, FIG. 4 is a perspective view schematically illustrating a hydraulic block for an electronic brake system according to an exemplary embodiment of the present disclosure, and FIG. 5 is a perspective view schematically illustrating a hydraulic block for an electronic brake system viewed in another direction according to an exemplary embodiment of the present disclosure.

Referring to FIGS. 1 to 5, the hydraulic assembly 1000 for an electronic brake system according to the exemplary embodiment of the present disclosure may include: a hydraulic block 200 in which a plurality of valves, flow paths, and pumps are installed to control braking hydraulic pressure supplied to a plurality of wheel cylinders; a motor 300 mounted on a front surface of the hydraulic block 200, and providing power to the pump; a reservoir 400 mounted on an upper side of a first side surface of the hydraulic block 200, and storing a brake fluid; a master cylinder 500 mounted on a second side surface of the hydraulic block 200, and generating liquid pressure; and an electronic control unit 100 mounted on a back surface of the hydraulic block 200, and controlling the motor and the plurality of valves.

Meanwhile, the electronic control unit 100 may include: a housing 110 in which the hydraulic block 200 is mounted on the front surface; a control unit 120 accommodated inside the housing 110 and controlling the motor and the plurality of valves; and a first connector 130 and a second connector 140 provided on the front surface of the housing 110 so as for the control unit 120 to be electrically connected to an external device.

As illustrated in FIG. 1, the housing 110 may have an accommodation space therein, and may be configured to include a housing body 111 of which one side is opened, and a cover 112 coupled to an opening surface of the housing body 111.

The hydraulic block 200 has a cubic body made of metal such as aluminum. Although not illustrated, an accommodation bore for accommodating multiple valves, sensors, etc., may be provided on each surface of the hydraulic block 200.

When placement of each component is described centered on the hydraulic block 200, the master cylinder 500 is mounted on one side of the hydraulic block 200. The master cylinder 500 which is a device that transmits the brake fluid according to a braking willingness of a driver includes an input rod 520 connected to a brake pedal, and a master piston (not illustrated) connected to the input rod 520, provided to move forward and backward in a master chamber, and pressing the brake fluid. Further, the master cylinder 500 may further include a pedal simulator provided in the master chamber and providing a pedal feel to the driver.

When the driver steps on the brake pedal, the input rod 520 connected to the brake pedal moves and the master cylinder 500 generates the liquid pressure. Therefore, the master cylinder 500 is mounted on one side of the hydraulic block 200 to be connected to the brake pedal provided on a vehicle body. Hereinafter, the side surface of the hydraulic block 200 on which the master cylinder 500 is mounted is referred to as a second side surface, and a side surface opposite to the second side surface of the hydraulic block 200 is referred to as a first side surface. In the exemplary embodiment illustrated in FIGS. 1 and 2, a left side surface of the hydraulic block 200 is the first side surface and a right side surface is the second side surface, but in another exemplary embodiment, on the contrary, the right side surface of the hydraulic block 200 may be the first side surface and the left side surface may be the second side surface.

A master cylinder accommodation bore 251 accommodating the master cylinder 500 and a pedal sensor accommodation bore 252 accommodating a pedal displacement sensor (not illustrated) may be formed on the second side surface of the hydraulic block 200. The master cylinder accommodation bore 251 may be arranged from the second side surface to the first side surface.

The master cylinder accommodation bore 251 may be disposed biased to one side on the second side surface. For example, the master cylinder accommodation bore 251 may be disposed on an upper side of the hydraulic block 200 so as to be closer to an upper surface on the second side surface.

The pedal sensor accommodation bore 252 accommodating the pedal displacement sensor is formed on one side of the master cylinder accommodation bore 251. At this time, the pedal sensor accommodation bore 252 may be provided to overlap with a part of the master cylinder accommodation bore 251.

The master cylinder 500, which transmits the brake fluid according to the braking willingness of the driver, is installed in the master cylinder accommodation bore 251. The master cylinder 500 may be mounted on a position corresponding to the master cylinder accommodation bore 251 on the first side surface of the hydraulic block 200.

A plurality of master cylinder fastening grooves 255 to be fastened by a fixation bolt fixing the master cylinder 500 may be provided on a periphery of the master cylinder accommodation bore 251 on the second side surface of the hydraulic block 200.

The master cylinder 500 includes a support plate 512 for being fixed to the vehicle body, and the support plate 512 may be fixed to the vehicle body through a bolt 511. Therefore, since other components may cause interference with the vehicle body in a first side surface direction of the hydraulic block 200, other components may not be disposed.

A pump accommodation bore 231 accommodating the pump supplying the liquid pressure may be formed on a front surface of the hydraulic block 200. A pump providing a pressure of the brake fluid is installed in the pump accommodation bore 231. At this time, a pump (not illustrated) may include a power conversion unit (not illustrated) converting a rotational movement into a linear movement, and a hydraulic piston (not illustrated) connected to the power conversion unit (not illustrated), advancing and retreating, and forming the liquid pressure.

The pump accommodation bore 231 may be disposed biased to one side on the front surface of the hydraulic block 200 and may be disposed not to overlap with the master cylinder accommodation bore 251 described above. For example, when the master cylinder accommodation bore 251 is disposed on the upper side, the pump accommodation bore 231 may be placed on a lower right end side so as to be closer to the second side surface and a lower surface on the front surface of the hydraulic block 200.

As illustrated in FIGS. 1 and 2, a motor 300 connected to the pump (not illustrated) may be mounted on the front surface of the hydraulic block 200 with a plurality of fixation bolts 630. Accordingly, a plurality of motor fastening grooves 235 to be fastened by the fixation bolt 630 fixing the motor 300 may be provided on a periphery of the pump accommodation bore 231.

The motor 300 may be mounted on a position corresponding to the pump accommodation bore 231 on the first surface of the hydraulic block 200. The motor 300 is provided to provide power so as for the pump (not illustrated) to generate the liquid pressure, and controlled by receiving an electric signal of the electronic control unit 100 through a motor connector (not illustrated).

Meanwhile, although not illustrated in the drawing, an accommodation bore in which multiple valves such as a NO valve and an NC valve are provided may be provided on the back surface of the hydraulic block 200. The electronic control unit 100 is mounted on the back surface of the hydraulic block 200 to electronically control multiple valves and connectors provided on the back surface of the hydraulic block 200.

The hydraulic block 200 may be mounted on the electronic control unit 100 with a plurality of fixation bolts 620. Accordingly, a plurality of through-holes 215 to be fastened by the fixation bolt 620 fixing the hydraulic block 200 to the electronic control unit 100 may be provided in the hydraulic block 200.

A reservoir connection port 241 which is in communication with the reservoir 400 storing the brake fluid is provided on the first side surface of the hydraulic block 200. At this time, the reservoir connection port may be disposed at the upper side on the first side surface.

The reservoir connection port 241 may be provided in the form of a plurality of holes for communicating with the reservoir 400 and spaced apart from each other, and may include, for example, master cylinder reservoir connection ports 241a and 241b connected to the master cylinder 500 through a separate flow path, and a pump reservoir connection port 241c connected to the pump through a separate flow path.

At least one reservoir fastening groove 245 to be fastened by a fixation bolt 640 for mounting the reservoir 400 may be provided on the first side surface of the hydraulic block 200. At this time, as illustrated in FIG. 4, the reservoir fastening groove 245 may also be provided on the upper surface of the hydraulic block 200, and as a result, the reservoir 400 may be firmly mounted.

The reservoir 400 may be mounted on a position corresponding to the reservoir connection port 241 on the first side surface of the hydraulic block 200.

Meanwhile, in another exemplary embodiment, the reservoir connection port 241 may be provided on the upper surface of the hydraulic block 200. The exemplary embodiment will be described later.

The wheel cylinder connection port 210 may be provided in the form of a plurality of holes to be in communication with a wheel cylinder (not illustrated), which may be disposed to be spaced apart from each other on the front surface of the hydraulic block 200.

At least some 210a and 210b of the plurality of wheel cylinder connection ports 210 may be arranged longitudinally in a transverse direction of the pump accommodation bore 231, and the remaining some 210c and 210d may be arranged horizontally in a longitudinal direction of the pump accommodation bore 231. For example, as illustrated in FIG. 2, when the pump accommodation bore 231 is provided at a lower right end on the front surface of the hydraulic block 200, one pair 210c and 210d of the plurality of wheel cylinder connection ports may be arranged in the transverse direction on the upper end of the pump accommodation bore 231, and the other pair 210a and 210b of the plurality of wheel cylinder connection ports may be arranged in the longitudinal direction at a left side of the pump accommodation bore 231.

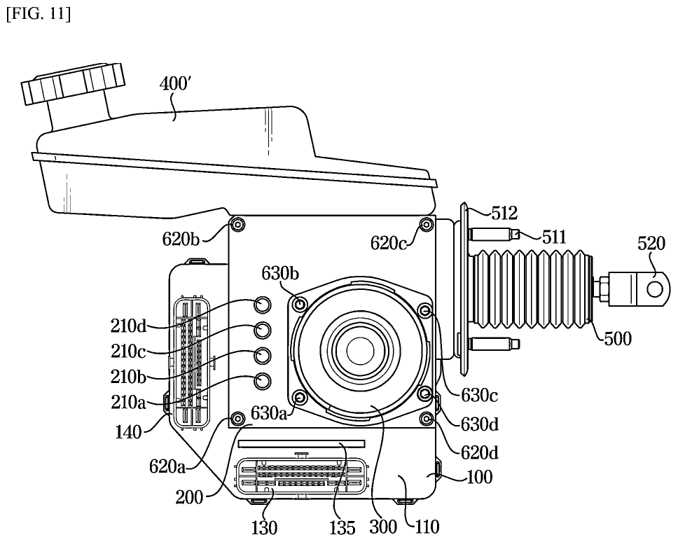

Alternatively, in another exemplary embodiment, all of the plurality of wheel cylinder connection ports 210 may be arranged longitudinally in the transverse direction of the pump accommodation bore 231. For example, as illustrated in FIGS. 11 to 13, when the pump accommodation bore 231 is provided on the lower right end on the front surface of the hydraulic block 200, four wheel cylinder connection ports 210a, 210b, 210c, and 210d may be arranged at the left side of the pump accommodation bore 231 in the longitudinal direction.

A first connector 130 may be disposed above the position on which the hydraulic block 200 is mounted. The motor 300 is mounted on the front surface of the hydraulic block 200, the electronic control unit 100 is mounted on the back surface, the reservoir 400 is mounted on the first side surface, and the master cylinder 500 is mounted on the second side surface. Accordingly, the first connector 130 is disposed above the hydraulic block 200 on which another component is not mounted to minimize the size of the hydraulic assembly 1000. Further, when the hydraulic assembly 1000 is installed in the vehicle body, the first connector 130 is disposed above the hydraulic block 200 to enhance assemblability.

Meanwhile, a second connector 140 may be disposed at a lower side on a position on which the reservoir 400 is mounted. Since the first connector 130 is disposed above the hydraulic block 200, a surface where another component is not disposed is a bottom surface of the hydraulic block 200, that is, a lower side. At this time, the second connector 140 may be disposed below the reservoir 400 mounted on the first side surface.

Meanwhile, the electronic control unit 100 may further include a second brake fluid shield 145 provided above the second connector 140 to prevent the brake fluid that may leak from the reservoir 400 from flowing into the second connector 140.

The second brake fluid shield 145 may be formed integrally with a portion of the housing 100 protruding to prevent the brake fluid from flowing into the second connector 140.

The second connector 140 may be disposed at a higher position than a bottom of the hydraulic block 200. As illustrated in FIG. 2, the second connector 140 is disposed at a position equal to or higher than the bottom of the hydraulic block 200. Therefore, a portion of the electronic control unit 100 that protrudes below the hydraulic block 200 is minimized. As described above, by preventing the electronic control unit 100 from protruding below the hydraulic block 200, interference with the vehicle body may be minimized when the hydraulic assembly 1000 is installed in the vehicle body.

The reservoir 400 may have a shape whose bottom becomes higher as moving away from the hydraulic block 200. The reservoir 400 stores brake fluid and supplies the brake fluid to the master cylinder and the pump through the reservoir connection port of the hydraulic block 200. The reservoir 400 has a shape where the bottom becomes higher as moving away from the hydraulic block 200, so that the stored brake fluid is collected and stored on the reservoir connection port side of the hydraulic block 200, and the brake fluid may be smoothly supplied.

Meanwhile, the second connector 140 may be disposed to be spaced apart at a predetermined distance from the first side surface of the hydraulic block 200 so as not to interfere with the reservoir 400. As described above, the second connector 140 is placed at a position higher than the bottom of the hydraulic block 200 to prevent the hydraulic assembly 1000 from interfering with the vehicle body. However, since the reservoir 400 is mounted on the first side surface of the hydraulic block 200, when the second connector 140 is disposed close to the first side surface of the hydraulic block 200, interference with the reservoir 400 may occur.

The second connector 140 may be disposed to be spaced apart at a predetermined distance from the first side surface of the hydraulic block 200 so as to avoid the interference with the reservoir 400 and enhance the assemblability. As illustrated in FIG. 2, the second connector 140 is placed to be spaced apart at a predetermined distance from the hydraulic block 200, thereby preventing interference with the bottom of the reservoir 400.

In the present disclosure, the first connector 130, the second connector 140, and the wheel cylinder connection port 210 are disposed in the hydraulic assembly 1000 as described above to minimize the interference with the vehicle body when the hydraulic assembly 1000 is installed in the vehicle body, and enhance the assemblability to the first connector 130, the second connector 140, and the wheel cylinder connection port 210.

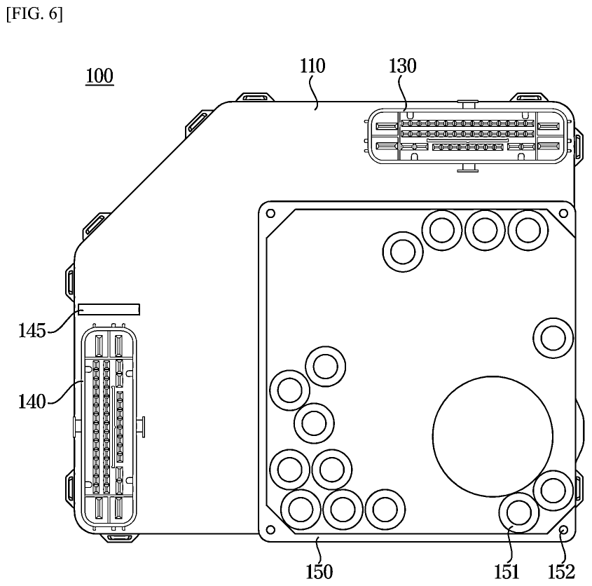

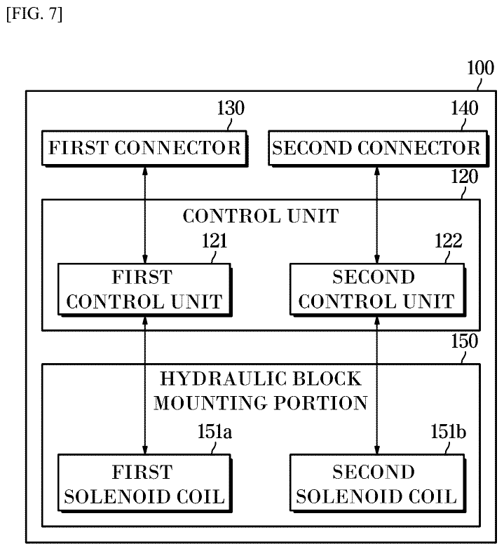

FIG. 6 is a front view schematically illustrating an electronic control unit for an electronic brake system according to an exemplary embodiment of the present disclosure, and FIG. 7 is a block diagram schematically illustrating an electronic control unit for an electronic brake system according to an exemplary embodiment of the present disclosure.

Referring to FIG. 6, the electronic control unit 100 may include: a housing 110 in which the hydraulic block 200 is mounted on the front surface; a control unit 120 accommodated inside the housing 110 and controlling the motor 300 and the plurality of valves; and a first connector 130 and a second connector 140 provided on the front surface of the housing so as for the control unit 120 to be electrically connected to an external device.

Meanwhile, a hydraulic block mounting portion 150 may be provided on the front surface of the housing 110 so that the hydraulic block 200 may be mounted. As illustrated in FIG. 6, a hydraulic block fastening hole 152 to which a bolt 620 penetrating the hydraulic block 200 is fastened may be provided so that the hydraulic block 200 may be mounted on the hydraulic block mounting portion 150.

Multiple solenoid coils 151 are provided in the hydraulic block mounting portion 150 to open/close multiple valves provided in the hydraulic block 200. The control unit 120 may control multiple valves by controlling the solenoid coil 151. Such a solenoid coil 151 may be placed to correspond to positions of multiple valves provided in the hydraulic block 200.

The control unit 120 may be accommodated inside the housing 110, and may control the motor 300 and multiple valves.

The control unit 120 may include a first control unit 121 that controls some valves among a plurality of valves; and a second control unit 122 that controls the remaining valves that are not controlled by the first control unit 121 among the plurality of valves.

Referring to FIG. 7, the control unit 120 may include the first control unit 121 and the second control unit 122. The first control unit 121 may control multiple first solenoid coils 151a, which are some of multiple solenoid coils 151 provided in the hydraulic block mounting portion 150, and the second control unit 122 may control multiple second solenoid coils 151b corresponding to the remaining solenoid coils. At this time, the multiple first solenoid coils 151a may open/close multiple valves that control the flow of the liquid pressure transmitted to the first and second wheel cylinders among the four wheel cylinders, and the multiple second solenoid coils 151b may open/close multiple valves that control the flow of the liquid pressure transmitted to the third and fourth wheel cylinders.

That is, the control unit 120 may separately control multiple valves, including the first control unit 121 and the second control unit 122. At this time, the first control unit 121 controls the valve that controls the flow of the liquid pressure transmitted to the first and second wheel cylinders, and the second control unit 122 controls the flow of the liquid pressure transmitted to the third and fourth wheel cylinders. As the control unit 120 includes two control units, even if a problem occurs in one of the control units, braking force may be generated by controlling the flow of the liquid pressure to at least two wheels.

For example, if an error occurs in the second control unit 122, control of the liquid pressure for the third and fourth wheel cylinders is impossible, but control of the liquid pressure for the first and second wheel cylinders is possible, so braking of the vehicle may be performed by transmitting the liquid pressure to the first and second wheel cylinders.

Meanwhile, the first connector 130 may be electrically connected to the first control unit 121, and the second connector 140 may be electrically connected to the second control unit 122. As each connector is electrically connected to each control unit, even if an error occurs in any one connector, the braking force may be generated by controlling the flow of the liquid pressure to at least two wheels.

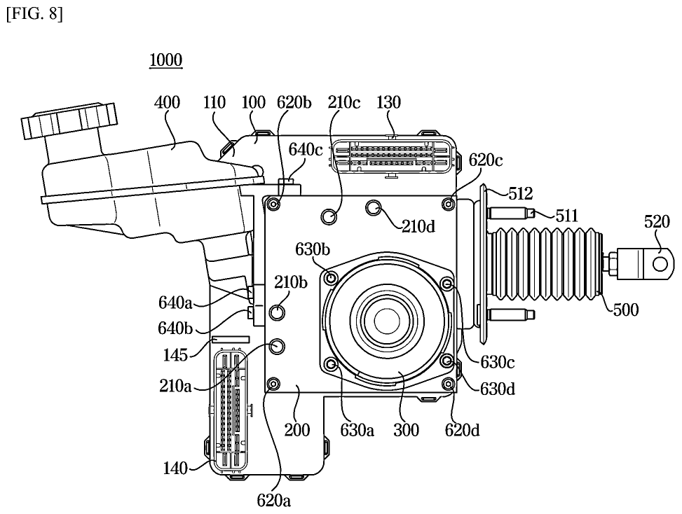

FIGS. 8 to 13 are front views schematically illustrating a hydraulic assembly for an electronic brake system according to another exemplary embodiment of the present disclosure.

As illustrated in FIGS. 8 to 13, in another exemplary embodiment of the present disclosure, the first connector 130 and the second connector 140 may be disposed in various positions. Hereinafter, another exemplary embodiment will be described. At this time, description of the same configuration as the above-described exemplary embodiment will be omitted.

In the exemplary embodiment illustrated in FIG. 8, the second connector 140 may be disposed below the reservoir 400 mounted on the first side surface of the hydraulic block 200. A difference from the exemplary embodiment illustrated in FIG. 2 is that in the exemplary embodiment illustrated in FIG. 8, the second connector 140 is disposed at a lower position than the bottom of the hydraulic block 200. As illustrated in FIG. 8, the second connector 140 is disposed at a lower position than the bottom of the hydraulic block 200, so that the second connector 140 protrudes less on a left surface of the hydraulic block 200 than the exemplary embodiment illustrated in FIG. 2 to occupy a smaller space in the engine room of the vehicle.

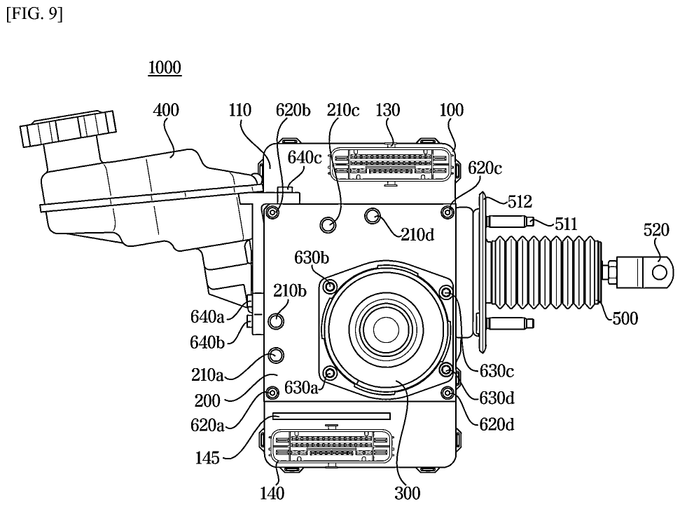

In the exemplary embodiment illustrated in FIG. 9, the second connector 140 may be disposed below the position on which the hydraulic block 200 is mounted. Similar to the exemplary embodiment illustrated in FIG. 8, the second connector 140 does not protrude to the left surface of the hydraulic block 200, thereby reducing the size of the hydraulic assembly 1000 and occupying the smaller space in the engine room of the vehicle.

However, when the second connector 140 is disposed below the hydraulic block 200, a second brake fluid shield 145 may be further included, which is provided above the second connector 140 so as to prevent the brake fluid which may leak from the hydraulic block 200 from flowing into the second connector 140. At this time, since the second connector 140 is disposed in a horizontally long direction, the second brake fluid shield 145 may also have a horizontally long shape to match the second connector 140.

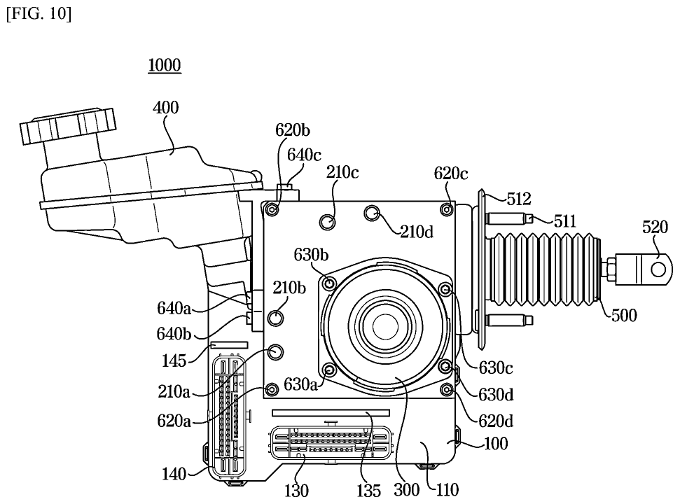

In the exemplary embodiment illustrated in FIG. 10, the first connector 130 may be disposed below the position where the hydraulic block 200 is mounted, and the second connector 140 may be disposed below the reservoir 400 mounted on the first side surface of the hydraulic block 200. There is an advantage in placing the hydraulic assembly 1000 in the engine room of the vehicle by placing the components of the hydraulic assembly 1000 not to protrude on the upper side of the hydraulic block 200.

Meanwhile, since the first connector 130 is disposed below the position on which the hydraulic block 200 is mounted, a first brake fluid shield 135 may be further included, which is provided above the first connector 130 so as to prevent the brake fluid which may leak from the hydraulic block 200 from flowing into the first connector 130. Similarly, since the second connector 140 is disposed below the hydraulic block 400, a second brake fluid shield 145 may be further included, which is provided above the second connector 140 so as to prevent the brake fluid which may leak from the reservoir 400 from flowing into the second connector 140.

In the exemplary embodiment illustrated in FIG. 11, a reservoir 400′ may be mounted on the upper surface of the hydraulic block 200. In the exemplary embodiment, a reservoir connection port 241 communicating with the reservoir 400′ may be provided on the upper surface of the hydraulic block 200.

As illustrated in FIG. 11, when the reservoir 400′ is mounted on the upper surface of the hydraulic block 200, it is advantageous for the design of a connection portion between the reservoir 400′ and the hydraulic block 200, and it is advantageous for the design of the flow path inside the hydraulic block 200.

As illustrated in FIG. 11, when the reservoir 400′ is mounted on the upper surface of the hydraulic block 200, the first connector 130 may be disposed below the position where the hydraulic block 200 is mounted, and the second connector 140 may be disposed on the outside of first side surface of the hydraulic block 200. Since the reservoir 400′ is mounted on the upper surface of the hydraulic block 200 rather than the first side surface, the second connector 140 may be disposed on the outside of the first side surface of the hydraulic block 200. Accordingly, the second connector 140 protrudes less on the hydraulic block 200 to occupy the smaller space in the engine room of the vehicle.

In addition, since the reservoir 400′ and the reservoir connection port 241 are provided on the upper surface of the hydraulic block 200, there is a low risk of brake fluid flowing into the second connector 140 disposed on the outside of the first side surface. Therefore, in the exemplary embodiment, the second brake fluid shield 145 above the second connector 140 may be omitted. However, since the first connector 130 is disposed below the position on which the hydraulic block 200 is mounted, the first brake fluid shield 135 may be further included, which is provided above the first connector 130 so as to prevent the brake fluid which may leak from the hydraulic block 200 from flowing into the first connector 130.

Meanwhile, when the reservoir 400′ is mounted on the upper surface of the hydraulic block 200, the wheel cylinder connection port 210 may be efficiently disposed, which is provided in the form of a plurality of holes for communicating with the wheel cylinder (not illustrated) through the flow path design inside the hydraulic block 200. In another exemplary embodiment illustrated in FIG. 11, the plurality of wheel cylinder connection ports 210 may be arranged longitudinally in the transverse direction of the pump accommodation bore 231.

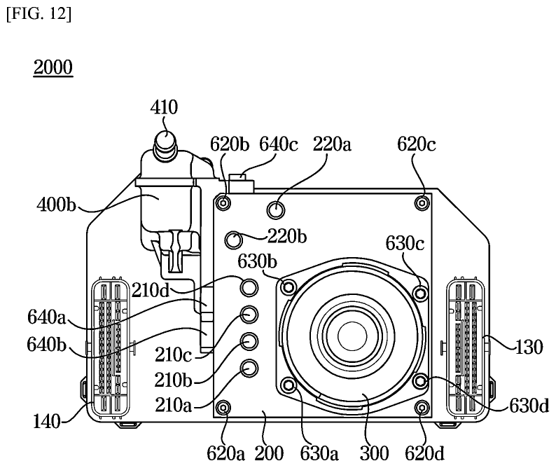

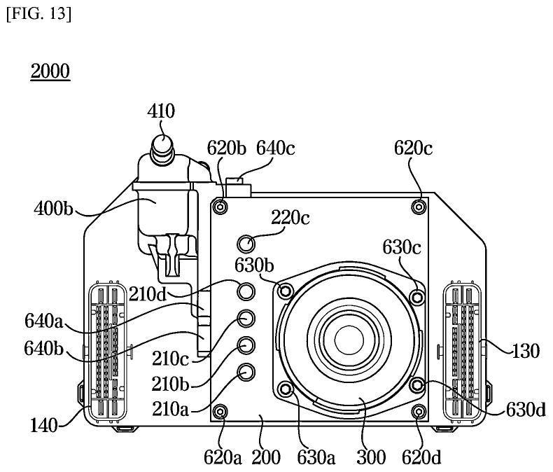

FIGS. 12 to 13 illustrate a hydraulic assembly for a module-type electronic brake system according to another exemplary embodiment of the present disclosure.

The module-type electronic brake system may be provided to include a first hydraulic assembly (not illustrated) including a master cylinder, a second hydraulic assembly 2000 including a hydraulic block and a motor, and a connection line (not illustrated) connecting the first hydraulic assembly and the second hydraulic assembly 2000. The first hydraulic assembly and the second hydraulic assembly 2000 are disposed to be spaced apart from each other in the vehicle, but may be hydraulically connected by a plurality of connection lines, thereby improving vehicle mountability of the electronic brake system and further promoting freedom in vehicle design, which may enable efficient spatial placement.

The first hydraulic assembly may include a master cylinder that includes an input rod connected to the brake pedal, and a master piston connected to the input rod, and provided to advance and retreat within the master chamber, and pressing the brake fluid; a main reservoir that stores the brake fluid; and a first hydraulic block connecting the main reservoir and the master cylinder.

The second hydraulic assembly 2000 may include a hydraulic block 200 in which a plurality of valves, flow paths, and pumps are installed to control braking hydraulic pressure supplied to a plurality of wheel cylinders; a motor 300 mounted on the front surface of the hydraulic block 200 and providing power to the pump; a sub reservoir 400b mounted on the upper side of the first side surface of the hydraulic block and connected to the main reservoir to receive and subsidiarily store the brake fluid; and an electronic control unit 100 mounted on the back surface of the hydraulic block 200 and controlling the motor and the plurality of valves.

That is, the second hydraulic assembly 2000 of the module-type electronic brake system illustrated in FIGS. 12 and 13 is different from the above-described hydraulic assembly 1000 in that a master cylinder 500 and a main reservoir 400a are provided in a separate first hydraulic assembly, and the sub reservoir 400b connected to the main reservoir 400a is included. The sub reservoir 400b may be provided with a reservoir connector 410 to be connected to the main reservoir 400a through a connection line.

In the exemplary embodiment illustrated in FIG. 12, the first connector 130 may be disposed on the outside of the second side surface of the hydraulic block 200, and the second connector 140 may be disposed below the sub reservoir 400b mounted on the first side surface of the hydraulic block 200. As described above, since the second hydraulic assembly 2000 does not include the master cylinder 500, the first connector 130 may be disposed on the outside of the second side surface. When the connectors are disposed on the first and second side surfaces of the hydraulic block 200, respectively, an inflow risk of the brake fluid which leaks from the hydraulic block 200 and the sub reservoir 400b may be reduced while reducing the size of the second hydraulic assembly 2000.

As illustrated in FIG. 12, the hydraulic block 200 may be provided with the wheel cylinder connection port 210 in the form of the plurality of holes for communicating with the wheel cylinder (not illustrated). In the exemplary embodiment illustrated in FIG. 12, the plurality of wheel cylinder connection ports 210 may be arranged longitudinally in the transverse direction of the pump accommodation bore 231.

Meanwhile, since the master cylinder 500 is provided in the separate first hydraulic assembly, the hydraulic block 200 may further include a master cylinder connection port 220 so that the liquid pressure generated from the master cylinder 500 may be transmitted. At this time, the master cylinder 500 may include two master pistons therein, and the hydraulic block 200 may include two master cylinder connection ports 220a and 220b so that the liquid pressure generated from each of the two master pistons may be transmitted.

As in the exemplary embodiment illustrated in FIG. 12, the plurality of wheel cylinder connection ports 210 may be arranged longitudinally in the transverse direction of the pump accommodation bore 231, and the two master cylinder connection ports 220a and 220b may be arranged horizontally in the longitudinal direction of the plurality of wheel cylinder connection ports 210.

Meanwhile, the exemplary embodiment illustrated in FIG. 13 shows a second hydraulic assembly 2000 that may be connected to the first hydraulic assembly provided with the master cylinder 500 including one master piston. When the master cylinder 500 includes one master piston, the hydraulic block 200 may include one master cylinder connection port 220c so that liquid pressure generated from one master piston may be transmitted.

As in the exemplary embodiment illustrated in FIG. 13, the plurality of wheel cylinder connection ports 210 may be arranged longitudinally in the transverse direction of the pump accommodation bore 231, and the master cylinder connection port 220c may be arranged in the longitudinal direction of the plurality of wheel cylinder connection port 210.

Meanwhile, although not illustrated, in the second hydraulic assembly 2000 of the module-type electronic brake system, as in the exemplary embodiment illustrated in FIG. 2, the first connector 130 may be disposed above the position where the hydraulic block 200 is mounted, and the second connector 140 may be disposed below the position where the reservoir 400 is mounted. In the exemplary embodiment, the size of the second hydraulic assembly 2000 may be larger compared to the exemplary embodiment illustrated in FIGS. 12 and 13, but the housing 110 of the hydraulic assembly 1000 of the exemplary embodiment illustrated in FIG. 2 may be shared, thereby showing a reduction effect in production costs.

In addition, the second hydraulic assembly 2000 of the module-type electronic brake system may include the sub reservoir 400b mounted on the upper surface of the hydraulic block 200 as in the exemplary embodiment illustrated in FIG. 11. In the exemplary embodiment, the reservoir connection port 241 communicating with the sub reservoir 400b may be provided on the upper surface of the hydraulic block 200. At this time, the first connector 130 may be disposed on the outside of the second side surface of the hydraulic block 200, and the second connector 140 may be disposed on the outside of the first side surface of the hydraulic block 200. That is, when the sub reservoir 400b is mounted on the upper surface of the hydraulic block 200, the first connector 130 and the second connector 140 are disposed on both side surfaces of the hydraulic block 200, respectively, and reduce an interval between the hydraulic block 200 and both connectors 130 and 140, thereby reducing the size of the second hydraulic assembly 2000.

As described above, the exemplary embodiments are described with reference to the accompanying drawings. Those skilled in the art to which the present disclosure pertains will understand that the present disclosure may be implemented in a different from the exemplary embodiments without changing the technical spirit or essential features of the present disclosure. The exemplary embodiments are exemplary and should not be construed as being limited.

1. An electronic control unit for an electronic brake system, comprising:
a housing in which a hydraulic block in which a plurality of valves, flow paths, and pumps are installed to control braking hydraulic pressure supplied to a plurality of wheel cylinders is mounted on a front surface;
a control unit accommodated inside the housing, and controlling a motor providing power to the pump, and the plurality of valves; and
a first connector and a second connector provided on the front surface of the housing so as for the control unit to be electrically connected to an external device,
wherein the first connector is disposed above a position where the hydraulic block is mounted, and
the second connector is disposed below a reservoir mounted on a first side surface of the hydraulic block.

2. The electronic control unit for an electronic brake system of claim 1, wherein the second connector is disposed at a higher position than a bottom of the hydraulic block.

3. The electronic control unit for an electronic brake system of claim 2, wherein the second connector is disposed to be spaced apart from the first side surface of the hydraulic block by a predetermined distance not to interfere with the reservoir having a shape in which the bottom becomes higher as moving away from the hydraulic block.

4. The electronic control unit for an electronic brake system of claim 1, wherein the control unit includes
a first control unit controlling some valves among the plurality of values, and
a second control unit controlling the remaining valves which are not controlled by the first control unit among the plurality of valves, and
the first connector is electrically connected to the first control unit, and
the second connector is electrically connected to the second control unit.

5. The electronic control unit for an electronic brake system of claim 1, further comprising:
a brake fluid shield provided above the second connector so as to prevent a brake fluid which may leak from the reservoir from flowing into the second connector.

6. An electronic control unit for an electronic brake system, comprising:
a housing in which a hydraulic block in which a plurality of valves, flow paths, and pumps are installed to control braking hydraulic pressure supplied to a plurality of wheel cylinders is mounted on a front surface;
a control unit accommodated inside the housing, and controlling a motor providing power to the pump, and the plurality of valves; and
a first connector and a second connector provided on the front surface of the housing so as for the control unit to be electrically connected to an external device,
wherein the first connector is disposed at the outside of a first side surface of a position where the hydraulic block is mounted, and
the second connector is disposed at the outside of a second side surface of the position where the hydraulic block is mounted.

7. A hydraulic assembly for an electronic brake system, comprising:
a hydraulic block in which a plurality of valves, flow paths, and pumps are installed to control braking hydraulic pressure supplied to a plurality of wheel cylinders;
a motor mounted on a front surface of the hydraulic block, and providing power to the pump;
a reservoir mounted above a first side surface of the hydraulic block, and storing a brake fluid;
a master cylinder mounted on a second side surface of the hydraulic block, and generating liquid pressure; and
an electronic control unit including a housing mounted on a back surface of the hydraulic block, a control unit accommodated inside the housing, and controlling the motor and the plurality of valves, and a first connector and a second connector provided on the front surface of the housing so as for the control unit to be electrically connected to an external device,
wherein the first connector is disposed above a position where the hydraulic block is mounted, and
the second connector is disposed below a position where the reservoir is mounted.

8. The hydraulic assembly for an electronic brake system of claim 7, wherein the second connector is disposed at a higher position than a bottom of the hydraulic block.

9. The hydraulic assembly for an electronic brake system of claim 8, wherein the reservoir has a shape in which a bottom becomes higher as moving away from the hydraulic block, and
the second connector is disposed to be spaced apart from the first side surface of the hydraulic block by a predetermined distance not to interfere with the reservoir.

10. The hydraulic assembly for an electronic brake system of claim 7, wherein the control unit includes
a first control unit controlling some valves among the plurality of values, and
a second control unit controlling the remaining valves which are not controlled by the first control unit among the plurality of valves, and
the first connector is electrically connected to the first control unit, and
the second connector is electrically connected to the second control unit.

11. The hydraulic assembly for an electronic brake system of claim 7, wherein the electronic control unit further includes a brake fluid shield provided above the second connector so as to prevent a brake fluid which may leak from the reservoir from flowing into the second connector.
